(19) United States
(12) Patent Application Publication
(10) Pub. No.: US 2026/0019276 A1
(43) Pub. Date: Jan. 15, 2026

(54) Device and method for generating locally verifiable aggregate signatures for the generation of attestations in a VNF-FG architecture platform

(71) Applicant: ORANGE, ISSY-LES-MOULINEAUX (FR)

(72) Inventors: Thibaut JACQUES, CHATILLON CEDEX (FR); Ghada ARFAOUI, CHATILLON CEDEX (FR)

(21) Appl. No.: 19/262,298

(22) Filed: Jul. 8, 2025

(30) Foreign Application Priority Data
Jul. 12, 2024 (FR) FR2407680

(51) Int. Cl. H04L 9/32; H04L 9/30

(52) U.S. Cl. CPC H04L 9/3247; H04L 9/3073; H04L 9/3221

(57) ABSTRACT

A method for signing a message mi, by a user device, from a zero-knowledge proof cryptographic protocol defined by an element g belonging to a group G₁ of order p, with p designating a prime integer, and elements u, v, r, s, t belonging to a group G₂, a hash function H and a current time period w. The method includes: a generating a pair of private and public keys, the private key including an element αi selected from the ring Z/pZ, the public key including a first element and a second element being a zero-knowledge proof of possession generated from the cryptographic protocol; and generating a signature σi of the message mi from the private key and a random variable 6, the signature including a first element σ1i and a second element σ2i.

### CROSS REFERENCE TO RELATED APPLICATION

The present application claims priority to French Patent Application No. FR2407680, filed Jul. 12, 2024, which is incorporated herein by reference in its entirety.

### TECHNICAL FIELD

The present disclosure relates to the general field of cryptography and more particularly concerns the methods and devices for digital authentication by electronic signature. In particular, the present disclosure concerns the provision of collective attestations in virtualized computing platforms.

### PRIOR ART

It is known to use attestation mechanisms that allow a target to authenticate to a verifier by demonstrating that it satisfies certain properties.

Conventionally, attestation mechanisms take the form of a protocol called “challenge-response” protocol during which the verifier sends a challenge to a target accompanied by a random variable, called nonce. The target generates proofs in response to this challenge and sends them to the verifier, the proof is generally done from the trusted root of the target. The proof generally consists in demonstrating, by the provision of attestation, that the target is in a particular configuration, in particular in an uncorrupted configuration.

Such a mechanism is also known to attest that a group of targets is in a particular, trustworthy and uncorrupted configuration. Conventionally, the messages from said targets are aggregated, thus forming a single message proving the status of a set of targets.

In the particular case of virtualized computing platforms including, among other things, a plurality of virtual machines and a hypervisor, not only the virtual machines but also the infrastructure of these virtual machines must be attested.

To do so, methods providing group attestation for all the virtual machines and their infrastructure are known. Typically, these methods are based on assigning a mapping linking the virtual machines and their hypervisors in the form of a spanning tree linking child nodes to parent nodes. Upon receipt of an attestation request, or “challenge”, the child nodes generate an attestation and transmit it to their parent node.

Some methods include the generation of an attestation report in the form of a Boolean, by the parent nodes, in addition to their own attestation, indicating whether the attestations of child nodes are valid (Boolean: 1) or whether at least one attestation of child nodes is invalid (Boolean: 0). This report allows the verifier to quickly obtain a global attestation of the set. This advantageously allows distributing the computational resources by parallelizing the attestation verifications. However, in the case of an invalid attestation, it is not possible to identify the target(s) having provided an invalid attestation, in other words to identify the target(s) that are not in a valid, i.e. trustworthy, configuration. Moreover, this requires, among other things, that the parent nodes can verify the attestation and therefore know what a valid attestation is for the child node, i.e. what a valid configuration is for said virtual machine and its hypervisor. This knowledge can be questionable, in particular in the context of a virtualized computing platform whose resources are held by a plurality of owning entities, which do not wish to share the internal infrastructures of their virtual machines with each other.

Other alternative methods include the aggregation of the individual attestations generated by the targets in order to obtain an aggregate attestation. This aggregate attestation is verified by the verifier at the top of the graph. However, the verification time for such methods is particularly long, the latter being linear to the number of attestations, and therefore of targets, contained in the aggregate attestation. Even if optimization methods exist and allow reducing these verification times in some cases, these improvements unfortunately offer limited time savings.

Generally, it is advantageous to be able to verify an aggregate signature at a particular position, in other words to be able to verify the attestation of a particular target. This is called “local verification”, as opposed to “global verification” aimed at verifying whether the aggregate attestation is valid as a whole. The least expensive methods rely on the generation of attestations whose messages have been signed with a single key. Other methods, operating the ZK-SNARK (Zero-Knowledge Succinct Non-interactive ARgument of Knowledge) algorithm, allow the local verification of aggregate attestations formed from messages signed by a plurality of keys, however these methods are extremely expensive.

Moreover, as mentioned above, there is a need to ensure the confidentiality of the configurations of the targets while allowing them to attest to the verifier that they are in a valid configuration. Classical methods, such as encryption, can be operated in order to protect the exchanged information. However, this implies that the target can trust the verifier. More recent approaches, such as the ZK-SNARK algorithm, allow the generation of proofs called zero-knowledge proofs. The idea behind these methods is that the target does not send its exact configuration as a proof but sends a proof that it is in a valid configuration among a set of possible valid configurations without revealing in which configuration it is.

There is therefore a real need to provide attestations that are free, at least partly, from the drawbacks inherent in the known methods mentioned above. Particularly, there is a need for attestations that can quickly verify the validity status of a plurality of targets in a virtualized computing platform, both as a whole and individually. There is also a need to improve the confidentiality in the attestation exchanges, in particular in the context of a virtualized computing platform whose resources are held by a plurality of owning entities. In general, there is a need to provide secure attestations that are quickly generated and can be quickly verified while limiting the required bandwidth.

JaeHyun et al, particularly describes in the article “Synchronized Aggregate Signatures: New Definitions, Constructions and Applications”, IACR, International Association For Cryptologic Research, a synchronized aggregate signature model. However, this signature model does not allow local verification of said aggregate signatures.

One or more aspects of the present disclosure meet all or part of these needs.

### SUMMARY

An exemplary aspect of the present disclosure relates to a method for signing a message mi, by a user device, from a zero-knowledge proof cryptographic protocol defined by an element g belonging to a cyclic group G₁ of order p, with p designating a prime integer, and elements u, v, r, s, t belonging to a cyclic group G₂ of order p, a hash function H and a current time period w, the method including:
a step of generating a pair of private and public keys, the private key including an element αi selected from the ring Z/pZ, the public key including a first element gai and a second element πᵢ being a zero-knowledge proof of possession generated from the cryptographic protocol,
a step of generating a signature σi of the message mi from the private key and a random variable 6, the signature including:

$$a first element {σ}_{1 i} = {( {vu}^{H ( m i )} )}^{α i} . {( {r}^{\vert lg ( w ) \vert} {s}^{w} t )}^{6} ,$$

$$and$$

$$a second element {σ}_{2 i} = {g}^{6} .$$

The user device can be advantageously comprised in a virtualized computing platform, including in particular a Root of Trust (ROT).

Conventionally, a root of trust is configured to execute one or more specific functions of securing the virtualized computing platform.

The virtualized computing platform can be used to ensure the functionalities of a mobile network or implement a VNF-FG (Virtual Network Functions-Forwarding Graph) architecture platform. An exemplary aspect of the present disclosure also relates to a method for signing a set of messages m₀, . . . , mₙ, implemented in a virtualized computing platform including a plurality of user devices, from a zero-knowledge proof cryptographic protocol defined by an element g belonging to a cyclic group G₁ of order p, with p designating a prime integer, and elements u, v, r, s, t belonging to a cyclic group G₂ of order p, a hash function H and a current time period w, the method including:
for each message mi of the set of messages, i belonging to the interval [0, n], with n a natural integer greater than or equal to 1, the signature of the message mi by a user device of the plurality of user devices, by means of a method for generating a signature as described previously so as to generate a signature for said message mi, called individual signature;
a step of aggregating all or part of the individual signatures previously generated during said current time period w so as to generate an aggregate signature including a first element and a second element.

The aggregation step may include the aggregation of individual signatures with each other and/or of previously generated aggregate signatures.

The aggregation step may include an interpolation of the first elements of the signatures to be aggregated, and an interpolation of the second elements of the signatures to be aggregated.

The aggregation step may be implemented by calculating the first element σ₁ and the second element ⊖₂ using the following formulas:

$${θ}_{1} = {\prod }_{i = 0}^{n} {σ}_{1 i} ; {θ}_{2} = {\prod }_{i = 0}^{n} {σ}_{2 i} \qquad [ Math . 1 ]$$

Correlatively, An exemplary aspect of the present disclosure concerns a user device able to sign a message mi from a zero-knowledge proof cryptographic protocol defined by an element g belonging to a cyclic group G₁ of order p, with p designating a prime integer, and elements u, v, r, s, t belonging to a cyclic group G₂ of order p, a hash function H and a current time period w, the user device including:
a generation module configured to generate a pair of private and public keys, the private key including an element αi selected from the ring Z/pZ, the public key including a first element g^{α}ᵢ and a second element πᵢ being a zero-knowledge proof of possession generated from the cryptographic protocol,
a generation module able to generate a signature σi of the message mi from the private key and a random variable [symbol] , said signature including a first element σ₁ᵢ= (vu^{H(mi)ai}.(r^{|lg(w)|}s^{w}t) [symbol] , and a second element σ₂ᵢ= [symbol] .

An exemplary aspect of the present disclosure also relates to a group of user devices as described above, all or part of which user devices further include:
an aggregation module able to aggregate all or part of the signatures generated by said user devices during the current time period w so as to generate an aggregate signature including a first element and a second element.

By “aggregate signature” is meant a signature including several individual signatures of different messages originating from different user devices aggregated together such that the resulting signature has a constant size, which is preferably the same size as an individual signature, and can be verified from the knowledge of the different messages and the associated public keys.

The aggregate signature obtained by an exemplary aspect of the present disclosure further allows the generation of aggregate signatures called synchronized aggregate signatures. By “synchronized aggregate signature” is meant an aggregate signature composed of individual signatures generated for the same current time period. This advantageously makes it possible to avoid attacks called replay attacks.

Thus, and in general, an exemplary aspect of the present disclosure proposes a method for generating signatures that can be generated from different pairs of public-private keys, making it possible not only to preserve the security of the exchanges within a group of user devices but also to perform a local verification of a signature in the aggregate signature.

Furthermore, the signature scheme allows an aggregation called “multi-hop” aggregation making it possible to aggregate the individual signatures gradually and not necessarily at once. In other words, the aggregation can relate to individual signatures exclusively, aggregate signatures exclusively, or both individual signatures and aggregate signatures. This advantageously makes it possible to perform the aggregation step within a graph.

The virtualized computing platform may have an architecture of the VNF-FG type, acronym for the expression “Virtual Network Functions-Forwarding Graph”, the user devices can be virtual machines, each hosting a Virtual Network Function (VNF). Such a graph includes an entry point and an exit point. Such an architecture is represented in FIG. 1.

The method may include a step of determining a spanning tree, commonly called “spanning tree”, on said virtualized computing platform, linking the user devices together, for example by the implementation of a “Spanning Tree Protocol” algorithm.

The method may further include a step of receiving, by said user device(s), an attestation request from a verifier, for example transmitted via the entry point. The signature of a message by a user device following the receipt of this attestation request by said user device so as to provide proof of valid configuration of said user device.

After generation of the signature following the receipt of an attestation request, a user device may transmit said signature to another user device.

An exemplary aspect of the present disclosure also relates to a method for verifying, by a verification device, an aggregate signature including a first element

⊖₁ and a second element ⊖₂ and generated for a set of messages m₀, . . . , mₙ by using a method for generating a signature according to an aspect of the disclosure, from a zero-knowledge proof cryptographic protocol defined by an element g belonging to a cyclic group G₁ of order p, with p designating a prime integer, and elements u, v, r, s, t belonging to a cyclic group G₂ of order p, a hash function H and a current time period w, the method including:
a step of verifying the equality:

$$e ( g , {θ}_{1} ) = e ( {\prod }_{i = 0}^{n} {g}^{{α}_{i}} , v ) \cdot e ( {\prod }_{i = 0}^{n} {g}^{{α}_{i} H ( {m}_{i} )} , u ) \cdot e ( {θ}_{2} , {r}^{\vert lg ( w ) \vert} {s}^{w} t ) , \qquad [ Math . 2 ]$$

where e designates a bilinear coupling defined on the groups G₁ and G₂ and with values in a cyclic group G_{T},
If said equality is verified, a step of validating said aggregate signature.

Preferably, the verification method according to an aspect of the disclosure includes a prior step of generating a key-message aggregate from the messages m₀, . . . , mₙ, the public keys g^{α}₀, . . . , g^{α}ₙ derived from the pairs of keys generated for the signature of said messages, and the hash function H.

The prior step of generating the key-message aggregate can advantageously be performed upstream and only once, thereby speeding up, by contrast, the verification step.

The key-message aggregate can include a first element apkm1 and a second element apkm2. The first element can be equal to the product of the first elements of the public keys g^{α}₀, . . . , g^{α}ₙ. The second element can be equal to the product of the g^{α}ᵢ^{H(m)} for i ranging from 0 to n.

The equality verification step can consist of the verification of the equality:

$$e ( g , {θ}_{1} ) = e ( apkm 1 , v ) \cdot e ( apkm 2 , u ) \cdot e ( {θ}_{2} , {r}^{\vert lg ( w ) \vert} {s}^{w} t ) \qquad [ Math . 3 ]$$

Such a step allows for constant time batch verification. This is in particular made possible by the absence of use of nonce in the generation of the individual signatures, without this absence affecting the security of the exchanges. Indeed, the use of a current time period for the aggregation ensures freshness of the signatures.

The constant time batch verification allows for a control of the verification duration, independently of the number of individual signatures forming said aggregate signature. Such verification requires the prior knowledge, by the verification device, of the messages expected from the batch as well as the public keys associated with said messages.

An exemplary aspect of the present disclosure also relates to a method for verifying an individual signature of a message mi comprised in an aggregate signature including a first element ⊖₁ and a second element ⊖₂ and generated for a set of messages m₀, . . . , mₙ, i belonging to the interval [0,n] by using a method for generating a signature according to an aspect of the disclosure, from a zero-knowledge proof cryptographic protocol defined by an element g belonging to a cyclic group G₁ of order p, with p designating a prime integer, and elements u, v, r, s, t belonging to a cyclic group G₂ of order p, a hash function H and a current time period w, the method including:
a step of verifying the equality:

$$e ( g , {θ}_{1} ) = e ( {g}^{{α}_{i}} \cdot {\prod }_{k ∈ [ 0 , n ] ∖ \{ i \}} {g}^{{α}_{k}} , v ) \cdot e ( {g}^{{α}_{i} H ( {m}_{i} )} \cdot {\prod }_{k ∈ [ 0 , n ] ∖ \{ i \}} {g}^{{α}_{k} H ( {m}_{k} )} , u ) \cdot e ( {θ}_{2} , {r}^{\vert lg ( w ) \vert} {s}^{w} t ) , \qquad [ Math . 4 ]$$

where e designates a bilinear coupling defined on the groups G₁ and G₂ and with values in a cyclic group G_{T},
If said equality is verified, a step of validating said individual signature.

Preferably, said method for verifying an individual signature includes a pre-processing step during which at least a first auxiliary information aux1, for example aux1=Π_{k∈[0,n]/{i}}g^{αk}, a second auxiliary information aux2, for example aux2=Π_{k∈[0,n]/{i}}g^{αkH(mk)} and a third auxiliary information aux3, for example aux3 =(i, π_{ZK}), with π_{ZK} a proof that the proofs of possession of the public keys are valid, are determined from the public keys g^{α}₀, . . . , g^{α}ₙ derived from the pairs of keys generated for the signature of said messages m₀, . . . , mₙ and said messages so as to pre-calculate terms of the equality of the verification step.

This pre-processing step can advantageously be performed upstream and only once, making it possible to accelerate, by contrast, the equality verification step.

Correlatively, an exemplary aspect of the present disclosure concerns a device for verifying an aggregate signature including a first element ⊖₁ and a second element ⊖₂ and generated for a set of messages m₀, . . . , mₙ by using a method for generating a signature according to an aspect of the disclosure, from a zero-knowledge proof cryptographic protocol defined by an element g belonging to a cyclic group G₁ of order p, with p designating a prime integer, and elements u, v, r, s, t belonging to a cyclic group G₂ of order p, a hash function H and a current time period w, the verification device including:
a verification module able to verify the equality:

$$e ( g , {θ}_{1} ) = e ( {\prod }_{i = 0}^{n} {g}^{{α}_{i}} , v ) \cdot e ( {\prod }_{i = 0}^{n} {g}^{{α}_{i} H ( {m}_{i} )} , u ) \cdot e ( {θ}_{2} , {r}^{\vert lg ( w ) \vert} {s}^{w} t ) , \qquad [ Math . 5 ]$$

where e designates a bilinear coupling defined on the groups G₁ and G₂ and with values in a cyclic group G_{T}, and
a module for validating the aggregate signature, activated if said equality is verified.

An exemplary aspect of the present disclosure also relates to an opening device including a generation module able to generate, from the messages m₀, . . . , mₙ, public keys g^{α}₀, . . . , g^{α}ₙ derived from the pairs of keys generated for the signature of said messages, and the hash function H, a key-message aggregate, so as to allow the verification module to perform a batch verification.

In particular embodiments of the disclosure, the opening device is included in the verification device.

An exemplary aspect of the present disclosure also relates to a verification device able to verify an individual signature of a message mi comprised in an aggregate signature including a first element ⊖₁ and a second element ⊖₂ and generated for a set of messages m₀, . . . , mₙ, i belonging to the interval [0,n] by using a method for generating a signature according to an aspect of the disclosure, from a zero-knowledge proof cryptographic protocol defined by an element g belonging to a cyclic group G₁ of order p, with p designating a prime integer, and elements u, v, r, s, t belonging to a cyclic group G₂ of order p, a hash function H and a current time period w, the method including:
a module for verifying the equality:

$$e ( g , {θ}_{1} ) = e ( {g}^{{α}_{i}} \cdot {\prod }_{k ∈ [ 0 , n ] ∖ \{ i \}} {g}^{{α}_{k}} , v ) \cdot e ( {g}^{{α}_{i} H ( {m}_{i} )} \cdot {\prod }_{k ∈ [ 0 , n ] ∖ \{ i \}} {g}^{{α}_{k} H ( {m}_{k} )} , u ) \cdot e ( {θ}_{2} , {r}^{\vert lg ( w ) \vert} {s}^{w} t ) , \qquad [ Math . 6 ]$$

where e designates a bilinear coupling defined on the groups G₁ and G₂ and with values in a cyclic group G_{T}, and
a module for validating the individual signature, activated if said equality is verified.

Preferably, said device for verifying an individual signature may include a pre-processing module able to determine at least a first auxiliary information aux1, a second auxiliary information aux2 and a third auxiliary information aux3 are determined from the public keys g^{α}₀, . . . , g^{α}ₙ derived from the pairs of keys generated for the signature of said messages m₀, . . . , mₙ and said messages.

In particular embodiments of the disclosure, the pre-processing module is integrated into an opening device according to an aspect of the disclosure, distinct from the verification device.

The auxiliary information advantageously allows calculating the equality more quickly. Moreover, it may be calculated upstream, the verification device knowing the expected messages and the public keys of the user devices whose signature is to be verified.

Finally, an exemplary aspect of the present disclosure concerns a communication system including:
a group of user devices according to an aspect of the disclosure, and
one or more verification devices according to an aspect of the disclosure.

Particularly, the communication system includes user devices held by a plurality of owning entities. Preferably, the communication system then includes a verification device for each owning entity able to verify individual and/or aggregate signatures relating exclusively to the user devices held by said owning entity, and a verification device able to verify signatures generated by all the user devices.

In some embodiments, the cryptographic protocol is based on the ZK-SNARK algorithm.

Although the calculation of the ZK-SNARK proof of possession can be very costly, the pre-processing step determining auxiliary information from public data combined with the fact that the verification device knows the expected signed messages makes it possible to calculate the auxiliary information in advance only once and to reuse it each time. Thus, even when the ZK-SNARK algorithm is operated, the implementation of the method for verifying an individual signature is efficient and practical.

Generally, an aspect of the disclosure thus allows the generation of a multi-signatory synchronized aggregate signature scheme verifiable in batches at constant time that can be verified locally and globally.

Furthermore, the prior step of generating the key-message aggregates allows particularly the implementation of a constant time batch verification, by a global verifier.

An aspect of the disclosure thus makes it possible to control attestations, in particular in a virtualized computing platform of the VNF-FG type, which are generated and verified, both locally and globally, efficiently while using a lower bandwidth than the known methods.

In particular embodiments, all or part of the steps of a method according to an aspect of the disclosure, preferably all the steps, are implemented by computer program instructions.

Thus, an aspect of the disclosure also aims a computer program including code instructions which, when executed by means of a computer, allow the implementation of a method according to an aspect of the disclosure as well as a computer-readable recording medium on which is recorded a computer program comprising instructions for the execution of the steps of a method according to an aspect of the disclosure.

The aforementioned characteristics and advantages, as well as others, will appear upon reading the following detailed description. This detailed description refers to the appended drawings.

### BRIEF DESCRIPTION OF THE DRAWINGS

The appended drawings are schematic and are primarily intended to illustrate the principles of the disclosure.

In these drawings, from one figure to the next, identical elements (or parts of elements) are identified by the same reference signs.

FIG. 1 is a virtualized computing platform according to an aspect of the disclosure.

FIG. 2 illustrates the steps of one exemplary implementation of an individual signature method by a user device according to an aspect of the disclosure,

FIG. 3 represents one example of functional architecture of a user device according to an aspect of the disclosure,

FIG. 4 illustrates the steps of one exemplary implementation of an aggregate signature method implemented by a group of user devices according to an aspect of the disclosure,

FIG. 5 represents one example of functional architecture of a user device according to an aspect of the disclosure,

FIG. 6 illustrates the steps of one exemplary implementation of a method for verifying a signature by a verification device according to an aspect of the disclosure,

FIG. 7 represents one example of functional architecture of a verification device according to an aspect of the disclosure,

FIG. 8 illustrates the steps of one exemplary implementation of another method for verifying a signature by a verification device according to an aspect of the disclosure,

FIG. 9 represents one example of functional architecture of a verification device according to an aspect of the disclosure,

FIG. 10 illustrates one example of hardware architecture of a user device and/or of a verification device and/or of a virtualized computing platform according to an aspect of the disclosure.

### DESCRIPTION OF THE EMBODIMENTS

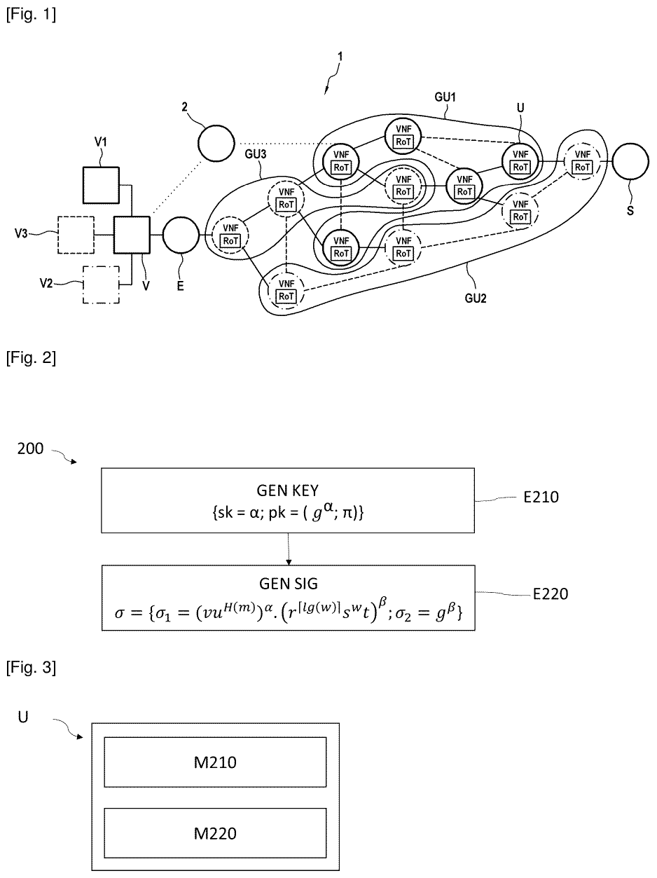

To make the disclosure more concrete, one example of a virtualized computing platform 1 including a plurality of user devices U and a plurality of verification devices V, V1, V2, V3 is represented in FIG. 1 and is described in detail below, with reference to the appended drawings. It is recalled that the present disclosure is not limited to this example.

In the illustrated example, the virtualized computing platform 1 has a VNF-FG type architecture including, among other things, an entry point E, an exit point S and a management device 2.

The user devices U may be virtual network functions, for example hosted in virtual machines. This example, although preferred, is not limiting.

The user devices may be held by different owning entities. For example, the user devices of the group GU1 of user devices may be held by a first owning entity, the user devices of the group GU2 of user devices may be held by a second owning entity, and the user devices of the group GU3 of user devices may be held by a third owning entity.

For each owning entity, the virtualized computing platform may include a verification device V1, V2, V3, called local verification device, able to verify an aggregate or individual signature of one or more user devices held by said owning entity.

The virtualized computing platform 1 preferably includes at least one verification device V, called global verification device, able to verify an aggregate signature of all the user devices of the virtualized computing platform.

Each user device U is able to sign a message m thanks to an aspect of the disclosure.

Generally, an aspect of the disclosure makes it possible to provide attestations intended to prove that the user devices are in a configuration corresponding to a valid status to a verification device.

To this end, an attestation request is sent, by a verification device, to the user devices of the virtualized computing platform. The request can be transmitted to the user devices via the entry point E and then propagated to the exit point S, via connections linking the user devices U to each other. In particular, the request is propagated along a spanning tree, commonly called “spanning tree”. The method may include a step of determining such a spanning tree on said virtualized computing platform, for example by the implementation of a “Spanning Tree Protocol” algorithm.

FIG. 1 represents a virtualized computing platform of VNF-FG type architecture on which one example of a “spanning tree” implementation has been calculated. The links in solid and dotted lines represent connections between the elements of the virtualized computing platform. The dotted lines however are not used by the spanning tree calculated by the “spanning tree” unlike the links in solid lines. Thus, in the example of FIG. 1, the request is propagated along the solid line links. Similarly, the messages signed by the user devices are advantageously forwarded and progressively aggregated up to the entry point E along the links in solid line.

Upon receipt of the request by a user device U, the latter generates an attestation in response to this request intended to prove that it is in a configuration corresponding to a valid status.

The generation of the attestation consists of the signature of a message m. The message m carries proof that said user device is in one of the configurations among a set of valid configurations indicated in said message m.

To allow such a signature, a cryptographic protocol is defined.

The cryptographic protocol can be determined by the manager device 2. Preferably, the manager device controls the infrastructure of the virtualized computing platform.

The cryptographic protocol is a zero-knowledge proof protocol. In particular, the cryptographic protocol is a ZK-SNARK type algorithm.

The cryptographic protocol is defined, among other things, by an element g belonging to a cyclic group G₁ of order p, with p designating a prime integer, and elements u, v, r, s, t belonging to a cyclic group G₂ of order p, a hash function H and a current time period w.

Preferably, a common clock is shared by the user devices and the verification device(s) so that the current time period is common.

Particularly, the clock may be positioned in the Root of Trust (ROT) of each of the user devices. Alternatively, the clock may be contained in the management device 2.

In order to provide the attestation in response to said request, each user device U implements a method 200 for signing a message m according to an aspect of the disclosure, as illustrated in FIG. 2.

The method 200 for signing a message m is performed from the zero-knowledge proof cryptographic protocol defined previously.

Said method 200 includes a step E210 of generating a pair of private and public keys, the private key including an element a selected from the ring Z/pZ, the public key including a first element g^{α} and a second element IT being a zero-knowledge proof of possession generated from the cryptographic protocol, and a step E220 of generating a signature o of the message m from the private key and a random variable [symbol] , the signature including a first element σ₁=(vu^{H(m))α}·(r^{∥g(w)|}s^{w}t) [symbol] , and a second element σ₂= [symbol] .

The proof of possession is proof that the user device is in possession of the private key a associated with the public key (g^{α}, π). Such proof of possession in particular allows avoiding rogue key attacks during an opening and/or local verification step.

Each user device U includes modules configured to implement a method 200 for generating a signature including at least one generation module M210 configured to implement a step E210 of generating a pair of private and public keys, a generation module M220 configured to implement a step E220 of generating a signature o of the message m.

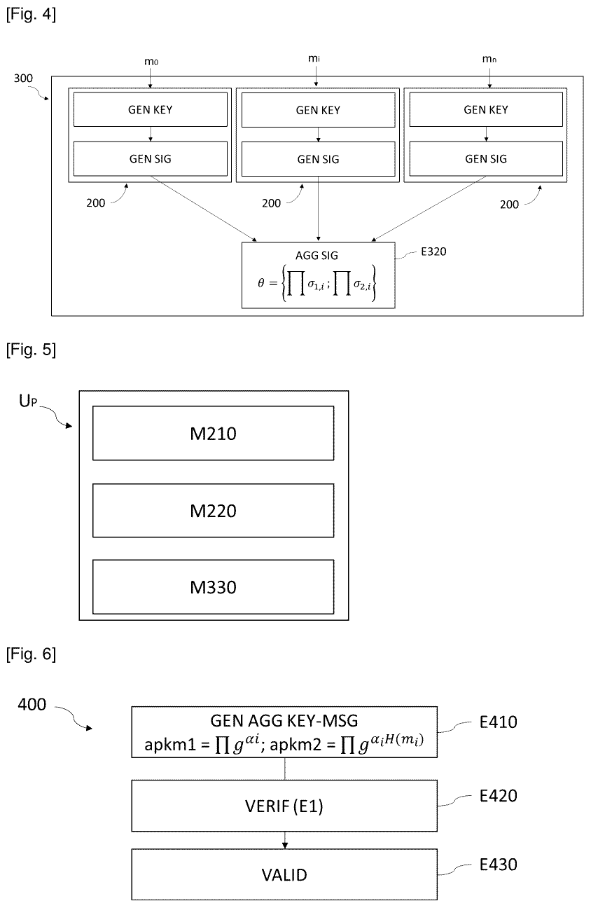

FIG. 4 represents a method 300 for signing a set of messages m₀, . . . , mₙ, implemented in a virtualized computing platform including a plurality of user devices U₀, . . . , Uₙ, from the zero-knowledge proof cryptographic protocol.

The method 300 includes: for each message mi of the set of messages, i belonging to the interval [0, n], the signature of the message mi by the corresponding user device Ui of the plurality of user devices, by means of the implementation of the method 200 for generating a signature as described previously so as to generate a signature σᵢ for said message mi called individual signature; then an aggregation step E320 of all or part of the individual signatures previously generated during said current time period w so as to generate an aggregate signature including a first element and a second element.

Preferably, the user devices called parent user devices Uₚ further include a module M330 for aggregating signatures generated by means of a method 200 for generating a signature according to an aspect of the disclosure, as illustrated in FIG. 5.

The parent user devices are user devices not directly linked to the exit point S.

The aggregation can be performed from individual signatures generated by the implementation of a method 200 and/or from aggregate signatures generated by the implementation of a method 300.

The individual signatures are progressively propagated from the user devices to the entry point E.

This aggregate signature formed from individual signatures generated by means of a method 300 according to an aspect of the disclosure is intended to be verified by a verification device V.

We will now describe with reference to FIG. 6 a method 400 for verifying an aggregate signature including a first element ⊖₁ and a second element ⊖₂ and generated for a set of messages m₀, . . . , mₙ by using a method for generating a signature according to an aspect of the disclosure, from a zero-knowledge proof cryptographic protocol, the method including a step E420 of verifying the equality:

$$\begin{matrix}( E1 ) & \\ e ( g , {θ}_{1} ) = e ( {\prod }_{i = 0}^{n} {g}^{{α}_{i}} , v ) \cdot e ( {\prod }_{i = 0}^{n} {g}^{{α}_{i} H ( {m}_{i} )} , u ) \cdot e ( {θ}_{2} , {r}^{\vert lg ( w ) \vert} {s}^{w} t ) , & [ Math . 7 ]\end{matrix}$$

where e designates a bilinear coupling defined on the groups G₁ and G₂ and with values in a cyclic group G_{T}, and
if said equality is verified, a step E430 of validating said aggregate signature.

The method 400 may further include a prior step E410 of generating a key-message aggregate from the messages m₀, . . . , mₙ, the public keys g^{α}₀, . . . , g^{α}ₙ derived from the pairs of keys generated for the individual signature of said messages, and the hash function H.

The key-message aggregate may include a first element apkm1 equal to the product of the first elements of the public keys g^{α}₀, . . . , g^{α}ₙ, and a second element apkm2 equal to the product of the g^{αiH(mi)} for i ranging from 0 to n. Such a step E410 allows constant time batch verification.

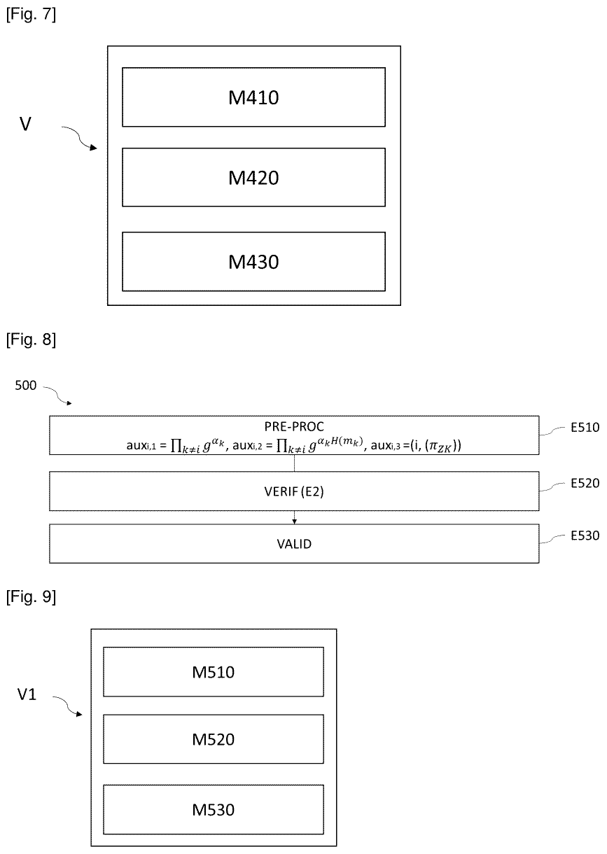

The verification device V includes modules configured to implement a method 400 for verifying an aggregate signature including at least one verification module M420 configured to implement a step 420 of verifying the equality above, and a validation module M430 configured to implement a step E430 of validating a signature. Such a device is illustrated in FIG. 7.

Preferably, the verification device V further includes a module M410 for generating a key-message aggregate configured to implement a step 410 of generating a key-message aggregate from the messages m₀, . . . , mₙ, the public keys g^{α}₀, . . . , g^{α}ₙ derived from the pairs of keys generated for the signature of said messages, and the hash function H.

Alternatively, the module M410 for generating a key-message aggregate may be comprised in an opening device (not represented), distinct from the verification device V.

In addition to the global verification described above, an aspect of the disclosure also relates to a local verification. In other words, an aspect of the disclosure allows the verification of the individual signatures of a subgroup of the devices of the virtualized computing platform.

Particularly, an aspect of the disclosure makes it possible to verify the individual signatures signed by user devices of a group of user devices held by a particular owning entity. For example, the verification device V1 may be configured to implement a method for verifying an individual signature generated by one of the devices of the subgroup of devices GU1.

With reference to FIG. 8, a method 500 for verifying an individual signature of a message mi comprised in an aggregate signature including a first element ⊖₁ and a second element σ2 and generated for a set of messages m₀, . . . , mₙ, i belonging to the interval [0,n] by using a method for generating a signature according to an aspect of the disclosure, from the zero-knowledge proof cryptographic protocol. The method 500 includes a step E520 of verifying the equality:

$$\begin{matrix}( E2 ) & \\ e ( g , {θ}_{1} ) = e ( {g}^{{α}_{i}} \cdot {\prod }_{k ∈ [ 0 , n ] ∖ \{ i \}} {g}^{{α}_{k}} , v ) \cdot e ( {g}^{{α}_{i} H ( {m}_{i} )} \cdot {\prod }_{k ∈ [ 0 , n ] ∖ \{ i \}} {g}^{{α}_{k} H ( {m}_{k} )} , u ) \cdot e ( {θ}_{2} , {r}^{\vert lg ( w ) \vert} {s}^{w} t ) , & [ Math . 8 ]\end{matrix}$$

where e designates a bilinear coupling defined on the groups G₁ and G₂ and with values in a cyclic group G_{T}, and
if said equality is verified, a step E530 of validating said individual signature σᵢ.

Said method 500 for verifying an individual signature σᵢ preferably includes a pre-processing step E510 during which at least a first auxiliary information auxi1, a second auxiliary information auxi2 and a third auxiliary information auxi3 are determined from the public keys g^{α}₀, . . . , g^{α}ₙ derived from the pairs of keys generated for the signature of said messages m₀, . . . , mₙ and said messages.

The first auxiliary information may be equal to:

[Math. 9] auxi1=Π^{k∈[0,n]/{i}}g^{αk}, with i the index of the message to be verified locally.

The second auxiliary information can be equal to:

[Math. 10] auxᵢ₂Π_{k∈[0,n]/{i}}g^{αkH(mk)}, with i the index of the message to be verified locally.

The third information can be equal to:

[Math. 11] auxᵢ₃=(i, π_{ZK}), with i the index of the message to be verified locally and π_{ZK} a proof that the proofs of possession of the public keys are valid.

The verification device V1, V2, V3 includes modules configured to implement a method 500 for verifying an individual signature including at least one verification module M520 configured to implement a step 520 of verifying the equality above, and a validation module M530 configured to implement a step

E530 of validating an individual signature.

Preferably, the verification device V1, V2, V3 further includes a pre-processing module M510 for implementing a step 510 of determining auxiliary information during which at least a first auxiliary information auxi₁, a second auxiliary information auxi2 and a third auxiliary information auxᵢ₃ are determined from the public keys g^{α}₀, . . . , g^{α}ₙ derived from the pairs of keys generated for the signature of said messages m₀, . . . , mₙ and said messages.

Alternatively, the pre-processing module M510 may be comprised in an opening device (not represented), distinct from the verification device V1, V2, V3.

In one particular embodiment, the different steps of the methods according to an aspect of the disclosure are determined by computer program instructions.

Consequently, an aspect of the disclosure also relates to a computer program on an information medium, this program being capable of being implemented in a user device, and/or a verification device according to an aspect of the disclosure or more generally in a computer, this program including instructions adapted to the implementation of the steps of a method according to an aspect of the disclosure as described above.

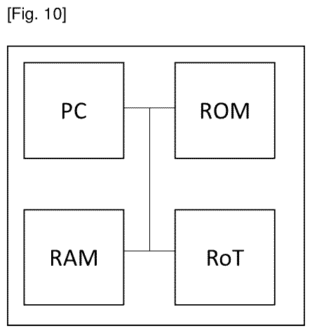

Thus, in particular embodiments, the virtualized computing platform 1 has the hardware architecture of a computer, as represented in FIG. 10. It should be noted that some elements of this architecture may be confused with existing devices.

More specifically, the virtualized signature computing platform 1 may include a processor PC, a read-only memory ROM, a random-access memory RAM, a root of trust ROT and communication means.

It should be noted that the root of trust may consist of software elements but is preferably implemented in the form of a hardware module.

The root of trust provides the platform securing services. Particularly, it is used to store and protect the platform keys. These keys cannot be used by the other resources without this root of trust.

This root of trust is for example constituted by a trusted module compliant with the ISO/IEC standards.

The read-only memory of the virtualized computing platform 1 constitutes a recording medium readable by the processor and on which a computer program in accordance with an aspect of the disclosure is recorded, including instructions for the execution of the steps of a method according to an aspect of the disclosure detailed above.

This computer program defines in an equivalent manner functional (software) modules of the virtualized computing platform 1.

This program may use any programming language, and be in the form of source code, object code, or intermediate code between source code and object code, such as in a partially compiled form, or in any other desirable form.

Similarly, in particular embodiments, the user devices U and/or the verification devices have the hardware architecture of a computer, as represented in FIG. 10. It should be noted that some elements of this/these architecture(s) may be confused with existing devices.

An aspect of the disclosure also relates to a computer-readable information or recording medium, and including instructions of a computer program as mentioned above.

The information or recording medium may be any entity or device capable of storing the program. For example, the medium may include a storage means such as a ROM, for example a CD ROM or a microelectronic circuit ROM, or a magnetic recording means for example a floppy disk or a hard disk.

On the other hand, the information or recording medium may be a transmissible medium such as an electrical or optical signal, which may be conveyed via an electrical or optical cable, by radio or by other means. The program according to an aspect of the disclosure may be particularly downloaded from an Internet-type network.

Alternatively, the information or recording medium may be an integrated circuit in which the program is incorporated, the circuit being adapted to execute or to be used in the execution of the method in question.

Although the present disclosure has been described with reference to specific exemplary embodiments, it is obvious that modifications and changes may be made to these examples without departing from the general scope of the disclosure or the inventions as defined by the claims. Particularly, individual characteristics of the various illustrated/mentioned embodiments may be combined in additional embodiments. Consequently, the description and the drawings should be considered in an illustrative rather than restrictive sense.

It is also obvious that all the characteristics described with reference to one method are transposable, alone or in combination, to one device, and conversely, all the characteristics described with reference to one device are transposable, alone or in combination, to one method.

1. A method comprising:
signing a message mi, by a user device, from a zero-knowledge proof cryptographic protocol defined by an element g belonging to a cyclic group G₁ of order p, with p designating a prime integer, and elements u, v, r, s, t belonging to a cyclic group G₂ of order p, a hash function H and a current time period w, the signing including:
generating a pair of private and public keys, the private key including an element αi selected from the ring Z/pZ, the public key including a first element gai and a second element πᵢ being a zero-knowledge proof of possession generated from the cryptographic protocol,
generating a signature σᵢ of the message mi from the private key and a random variable [symbol] , the signature including:
$$a first element {σ}_{1 i} = {( {vu}^{H ( m i )} )}^{ai} \cdot , and$$
$$a second element {σ}_{2 i} = .$$

2. The method according to claim 1, further comprising:
signing a set of messages mi, i belonging to the interval [0, n], in a virtualized computing platform including a plurality of user devices, the set of messages being denoted m₀, . . . , mₙ, by:
for each message mi of the set of messages, performing the signing of the message mi by a user device of the plurality of user devices so as to generate the signature for said message mi, called individual signature;
aggregating all or part of the individual signatures previously generated during said current time period w so as to generate an aggregate signature including a first element σ₁ and a second element σ2.

3. The signature method according to claim 2, wherein the aggregating includes aggregating the individual signatures with each other and/or of previously generated aggregate signatures.

4. The signature method according to claim 2, wherein the virtualized computing platform has an architecture of the VNF-FG (Virtual Network Functions-Forwarding Graph) type.

5. A method implemented by a device and comprising:
verifying, by a verification device, an aggregate signature including a first element ⊖₁ and a second element σ₂ and generated for a set of messages m₀, . . . , mₙ by using a method for generating a signature from a zero-knowledge proof cryptographic protocol defined by an element g belonging to a cyclic group G₁ of order p, with p designating a prime integer, and elements u, v, r, s, t belonging to a cyclic group G₂ of order p, a hash function H and a current time period w, in which:
the set of messages m₀, . . . , mₙ are signed in a virtualized computing platform including a plurality of user devices, by:
for each message mi of the set of messages, i belonging to the interval [0, n], signing of the message mi by a user device of the plurality of user devices so as to generate an individual signature for said message mi by generating a pair of private and public keys, the private key including an element αi selected from the ring Z/pZ,
the public key including a first element ga, and a second element Tri being a zero-knowledge proof of possession generated from the cryptographic protocol, and generating a signature σᵢ of the message mi from the private key and a random variable [symbol] , the individual signature including:
a first element σ₁ᵢ=(vu^{H(mi))αi}·(r^{|lg(w)|}s^{w}t) [symbol] , and
a second element σ₂ᵢ= [symbol] ; and
aggregating all or part of the individual signatures previously generated during said current time period w so as to generate the aggregate signature including the first element ⊖₁ and the second element ⊖₂;
the verifying including:
verifying the equality:
$$e ( g , {θ}_{1} ) = e ( {\prod }_{i = 0}^{n} {g}^{{α}_{i}} , v ) \cdot e ( {\prod }_{i = 0}^{n} {g}^{{α}_{i} H ( {m}_{i} )} , u ) \cdot e ( {θ}_{2} , {r}^{\vert lg ( w ) \vert} {s}^{w} t ) ,$$
designates a bilinear coupling defined on the groups G₁ and G₂ and with values in a cyclic group G_{T},
in response to said equality being verified, validating said aggregate signature.

6. The verification method according to claim 5, including, prior to the verifying, generating a key-message aggregate from the messages m₀, . . . , mₙ, the public keys g^{α}₀, . . . , g^{α}ₙ derived from the pairs of keys generated for the signature of said messages, and the hash function H.

7. A method implemented by a device and comprising:
verifying an individual signature of a message mi comprised in an aggregate signature including a first element ⊖₁ and a second element ⊖₂ and generated for a set of messages m₀, . . . , mₙ, i belonging to the interval [0,n] by using a method for generating a signature from a zero-knowledge proof cryptographic protocol defined by an element g belonging to a cyclic group G₁ of order p, with p designating a prime integer, and elements u, v, r, s, t belonging to a cyclic group G₂ of order p, a hash function H and a current time period w, in which:
the set of messages m₀, . . . , mₙ are signed in a virtualized computing platform including a plurality of user devices, by:
for each message mi of the set of messages, i belonging to the interval [0, n], signing of the message mi by a user device of the plurality of user devices so as to generate the individual signature for said message mi by generating a pair of private and public keys, the private key including an element αi selected from the ring Z/pZ, the public key including a first element g^{α}ᵢ and a second element Tri being a zero-knowledge proof of possession generated from the cryptographic protocol, and generating a signature σᵢ of the message mi from the private key and a random variable [symbol] , the individual signature including:
a first element σ₁ᵢ=(Vu^{H(mi)αi}·(r^{|lg(w)|}s^{w}t) [symbol] , and
a second element σ₂ᵢ= [symbol] ; and
aggregating all or part of the individual signatures previously generated during said current time period w so as to generate an aggregate signature including the first element ⊖₁ and the second element ⊖₂;
the verifying including:
verifying the equality:
$$e ( g , {θ}_{1} ) = e ( {g}^{{α}_{i}} \cdot {\prod }_{k ∈ [ 0 , n ] ∖ \{ i \}} {g}^{{α}_{k}} , v ) \cdot e ( {g}^{{α}_{i} H ( {m}_{i} )} \cdot {\prod }_{k ∈ [ 0 , n ] ∖ \{ i \}} {g}^{{α}_{k} H ( {m}_{k} )} , u ) \cdot e ( {θ}_{2} , {r}^{\vert lg ( w ) \vert} {s}^{w} t ) ,$$
where e designates a bilinear coupling defined on the groups G₁ and G₂ and with values in a cyclic group G_{T},
in response to said equality being verified, a step of validating said individual signature.

8. The method according to claim 7 including a pre-processing step during which at least a first auxiliary information aux1, a second auxiliary information aux2 and a third auxiliary information aux3 are determined from the public keys g^{α}₀, . . . , g^{α}ₙ derived from the pairs of keys generated for the signature of said messages m₀, . . . , mₙ and said messages so as to pre-calculate terms of the equality of the verification.

9. A user device comprising:
at least one processor; and
at least one non-transitory computer readable medium comprising instructions stored thereon which when executed by the at least one processor configure the user device to sign a message mi from a zero-knowledge proof cryptographic protocol defined by an element g belonging to a cyclic group G₁ of order p, with p designating a prime integer, and elements u, v, r, s, t belonging to a cyclic group G₂ of order p, a hash function H and a current time period w, the signing including:
generating a pair of private and public keys, the private key including an element αᵢ selected from the ring Z/pZ, the public key including a first element g^{α}ᵢ and a second element πᵢ being a zero-knowledge proof of possession generated from the cryptographic protocol, and
generating a signature σᵢ of the message mi from the private key and a random variable [symbol] , said signature including a first element σ₁ᵢ=(vu^{H(mi))αi}·(r^{|lg(w)|}s^{w}t) [symbol] , and a second element σ₂ᵢ= [symbol] .

10. A device comprising:
at least one processor; and
at least one non-transitory computer readable medium comprising instructions stored thereon which when executed by the at least one processor configure the device to verify an aggregate signature including a first element ⊖₁ and a second element σ₂ and generated for a set of messages m₀, . . . , mₙ by using a method for generating a signature from a zero-knowledge proof cryptographic protocol defined by an element g belonging to a cyclic group G₁ of order p, with p designating a prime integer, and elements u, v, r, s, t belonging to a cyclic group G₂ of order p, a hash function H and a current time period w, the verifying including:
verifying the equality:
$$e ( g , {θ}_{1} ) = e ( {\prod }_{i = 0}^{n} {g}^{{α}_{i}} , v ) \cdot e ( {\prod }_{i = 0}^{n} {g}^{{α}_{i} H ( {m}_{i} )} , u ) \cdot e ( {θ}_{2} , {r}^{\vert lg ( w ) \vert} {s}^{w} t ) ,$$
where e designates a bilinear coupling defined on the groups G₁ and G₂ and with values in a cyclic group G_{T}, and
validating an aggregate signature, activated in response to said equality being verified.

11. A verification device comprising:
at least one processor; and
at least one non-transitory computer readable medium comprising instructions stored thereon which when executed by the at least one processor configure the device to verify able to verify an individual signature of a message mi comprised in an aggregate signature including a first element ⊖₁ and a second element σ₂ and generated for a set of messages m₀, . . . , mₙ, i belonging to the interval [0,n] by using a method for generating a signature from a zero-knowledge proof cryptographic protocol defined by an element g belonging to a cyclic group G₁ of order p, with p designating a prime integer, and elements u, v, r, s, t belonging to a cyclic group G₂ of order p, a hash function H and a current time period w, the verifying including:
verifying the equality:
$$e ( g , {θ}_{1} ) = e ( {g}^{{α}_{i}} \cdot {\prod }_{k ∈ [ 0 , n ] ∖ \{ i \}} {g}^{{α}_{k}} , v ) \cdot e ( {g}^{{α}_{i} H ( {m}_{i} )} \cdot {\prod }_{k ∈ [ 0 , n ] ∖ \{ i \}} {g}^{{α}_{k} H ( {m}_{k} )} , u ) \cdot e ( {θ}_{2} , {r}^{\vert lg ( w ) \vert} {s}^{w} t ) ,$$
where e designates a bilinear coupling defined on the groups G₁ and G₂ and with values in a cyclic group G_{T}, and
validating the individual signature, activated in response to said equality being verified.

12. A non-transitory computer readable medium comprising a computer program stored thereon including code instructions which, when executed by at least one processor of the user device, configure the user device to implement the method according to claim 1.

13. A non-transitory computer-readable recording medium on which is recorded a computer program comprising instructions which when executed by at least one processor of the device, configure the device to implement the method according to claim 5.

14. A non-transitory computer-readable recording medium on which is recorded a computer program comprising instructions which when executed by at least one processor of the device, configure the device to implement the method according to claim 7.
